(19) United States
(12) Patent Application Publication
(10) Pub. No.: US 2010/0038455 A1
(43) Pub. Date: Feb. 18, 2010

(54) LIQUID EJECTOR

(75) Inventor: IAN JAMES TOON, Leicester (GB)

Correspondence Address: MCCORMICK, PAULDING & HUBER LLP, CITY PLACE II, 185 ASYLUM STREET, HARTFORD, CT, 06103, US

(73) Assignee: ROLLS-ROYCE PLC, London (GB)

(21) Appl. No.: 12/508,160

(22) Filed: Jul. 23, 2009

(30) Foreign Application Priority Data
Aug. 14, 2008 (GB) 0814791.0

(51) Int. Cl. B05B 1/26

(52) U.S. Cl. 239/518

(57) ABSTRACT

An ejector, which finds particular application as a fuel injector for a gas turbine engine, has an axially located passage ending as a nozzle having an internal surface facing radially inwardly towards the axis and which extends as an outboard cone about the axis of the passage and which terminates at a tip. The cone has a profile which replicates the unconstrained trajectory of the fuel leaving the passage. The outer surface of the ejector has a profile for accelerating a gaseous flow over the outer surface. Atomisation of fuel is improved along with relight capability, flame extinction and smoke production.

### CROSS REFERENCE TO RELATED APPLICATION

This application is entitled to the benefit of British Patent Application No. GB 0814791.0, filed on Aug. 14, 2008.

### FIELD OF THE INVENTION

This invention relates to liquid ejectors in general but particularly to fuel injectors, which may be used in a gas turbine engine.

### BACKGROUND OF THE INVENTION

There is a continuing need, driven by environmental concerns and governmental regulations, for improving the efficiency of and decreasing the emissions from gas turbine engines of the type utilised to power jet aircraft, marine vessels or generate electricity. Particularly there is a continuing drive to reduce nitrous oxide (NOₓ) emissions.

Advanced gas turbine combustors must meet these requirements for lower NOₓ emissions under conditions in which the control of NOₓ generation is very challenging. For example, the goal for the Ultra Efficient Engine Technology (UEET) gas turbine combustor research being done by NASA is a 70 percent reduction in NOₓ emissions and a 15 percent improvement in fuel efficiency compared to ICAO 1996 standards technology. Realisation of the fuel efficiency objectives will require an overall cycle pressure ratio as high as 60 to 1 and a peak cycle temperature of 1600° C. or greater. The severe combustor pressure and temperature conditions required for improved fuel efficiency make the NOₓ emissions goal much more difficult to achieve.

Conventional fuel injectors that seek to address this issue have concentrically arranged pilot and main injectors with the main injector surrounding the pilot injector. However, conventional injector arrangements have several operational disadvantages, including for example, flame stability and relight characteristics, the potential for excessive combustor dynamics or pressure fluctuations caused by combustor instability.

Stability and relight are particular requirements for the pilot injector which operates at low power requirements. The pilot sprayer has a very low fuel delta pressure at altitude relight, below that which conventional pressure spray injectors atomise the fuel. Stability is improved through the use of an airspray pilot which has an additional core air swirler and heatshield and which offers an improved atomisation and fuel distribution within the combustor.

In comparison to a pressure-jet atomiser an airspray atomiser is more complex, adding to the development and build cost of the whole injector.

A known fuel injector is known from U.S. Pat. No. 6,986,255 and depicted in the prior art diagram, FIG. 4. The pilot injector has a thick rim that shelters the fuel from high velocity air swirled by swirl vanes 104 through passage 101. At low fuel velocities typically seen at altitude relight the atomisation is limited and results in larger fuel droplets which limit the altitude relight capability.

### SUMMARY OF THE INVENTION

It is an object of the present invention to seek to provide an improved ejector.

According to a first aspect of the invention there is provided a pressure jet liquid ejector comprising an axially located passage ending as a nozzle having an internal surface facing radially inwardly towards the axis, extending as an outboard cone about the axis of the bore and terminating at a tip, and an outer surface facing radially outwardly away from the axis and intersecting with the internal surface at the tip, wherein the outer surface has a profile for accelerating a gaseous flow over the outer surface.

Preferably the outer surface has a radius from the axis that varies along the axial length of the outer surface to provide the profile.

The radius along the axial direction may decrease and then increase to provide an annular depression with an axially rearward lead in and an axially forward lead out.

Preferably the outer surface has an axially extending annular portion of constant radius between the end of the axially forward lead out and the tip.

The outboard cone may extend outwardly at an angle between 30° and 70° to the axis but more likely to be between 30° and 40° to the axis. The outboard cone angle preferably replicates the unconstrained trajectory of swirling fuel leaving the passage in use at the highest fuel flow required.

Preferably at least part of the passage is radially inward of an insulating sleeve for providing resistance to the transfer of heat from the gaseous flow to the passage, wherein the outer surface of the insulating sleeve provides at least part of the outer surface.

The supply passage preferably has swirl means for imparting swirl to a liquid which flows through the supply passage in use.

The ejector may have a housing which defines with the outer surface a gaseous flow passage through which, in use, a gas flows. The gas is preferably air.

Preferably the gaseous flow passage has swirling means for imparting swirl to the gas flow.

Preferably the axis of the ejector is the axis of a lean burn fuel injector for a gas turbine and the injector further comprises a further fuel injector arranged concentrically about the axis and located radially outwardly of the outer surface.

Preferably the liquid to be ejected and supplied through the supply passage is fuel which is then injected into the combustor of a gas turbine engine.

### BRIEF DESCRIPTION OF THE DRAWINGS

FIG. 1 depicts a pressure spray nozzle in accordance with the invention

FIG. 2 depicts a cross-section of a pressure spray nozzle in accordance with the invention.

FIG. 3 shows a comparison of spray from a nozzle in accordance with the invention (52) and a conventional nozzle (50)

### DETAILED DESCRIPTION OF THE PREFERRED EMBODIMENTS

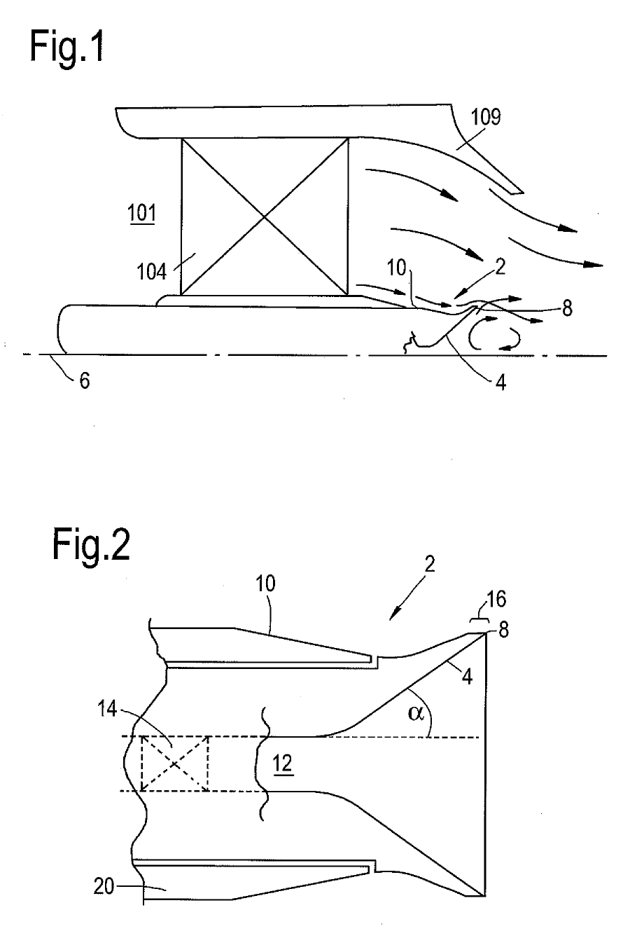

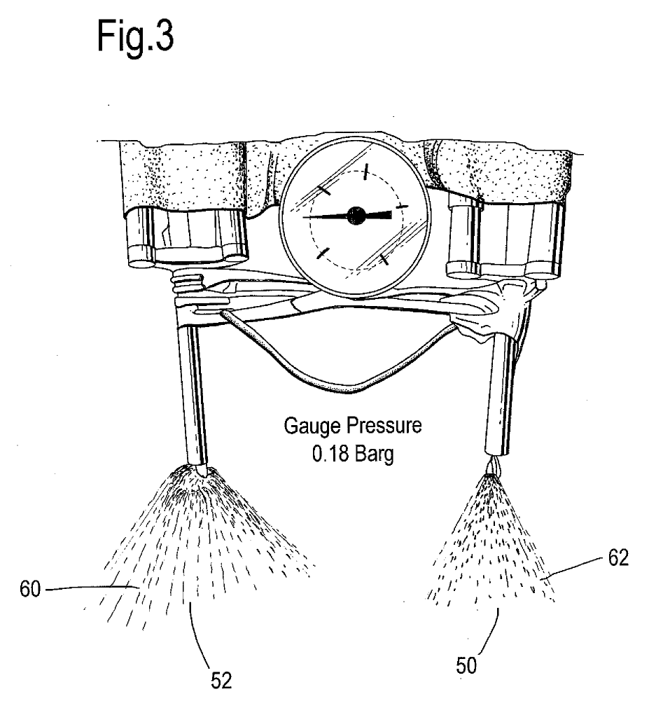

FIG. 1 depicts a pressure-spray nozzle having an improved tip. It should be viewed in conjunction with FIG. 2 which shows a second embodiment of the nozzle which operates with similar principles.

For reference, the nozzle 2 is located on the axis of a fuel injector and could replace component 102 of the prior art figures.

The nozzle 2 has an internal surface 4 which faces towards the centreline of the ejector 6 right to its tip 8 where it intersects with an outer surface 10 which faces away from the ejector axis 6.

The nozzle is supplied with fuel from an axially arranged fuel passage 12. An array of swirl vanes 14 or other swirl generating means impart swirl to the fuel which feeds onto the outwardly extending cone of the internal surface 4. The angle of the cone (α) to the axis of the ejector and the profile of the transition from the fuel passage 12 to the cone 4 replicates the unconstrained trajectory of the swirling fuel leaving the outlet of the passage 12 at the highest fuel flow required. This prevents the fuel film from separating from the surface and maximises the fuel film velocity on the surface. The maximised velocity minimises the fuel film thickness which consequently minimises the droplet size when the fuel film is atomised at the tip of the ejector to optimise the relight capability, flame extinction and improve smoke emissions. By blending the internal surface of the cone to the wall of the passage it is possible to avoid the presence of sharp edges which can cause the fuel film to detach.

For the primary application of the ejector, in a gas turbine fuel injector, the angle α is typically between 30° and 70° but is more often within the range 30° and 40°.

The outer surface 10 of the nozzle has a profile which accelerates an airflow towards the tip. The profile has an annular depression around the nozzle axis that has a streamlined lead in and a streamlined lead out. A short, axially extending portion 16 may be provided to link the lead out portion of the depression with the intersection with the internal surface at the internal surface tip S. The acceleration of the air flow minimises the boundary surface on the outer surface and maximises the air velocity at the tip, which is also the location at which the air flow impacts the fuel and atomisation of the fuel is effected.

Air is supplied through a swirl passage 101 and swirl is imparted to the air as it flows through a swirler 104. The outer wall of the swirl passage has a contraction 109 that also helps to maintain the velocity of the air flow through the swirl passage.

In FIG. 2, a cylindrical sleeve 20 is placed about the nozzle. The sleeve acts as a heatshield to minimise the heat transfer from the hot air flowing through the air swirler passage to the fuel. Beneficially thermal fuel breakdown is inhibited which helps to prevent blockage of the fuel passage that may occur if the fuel is allowed to coke.

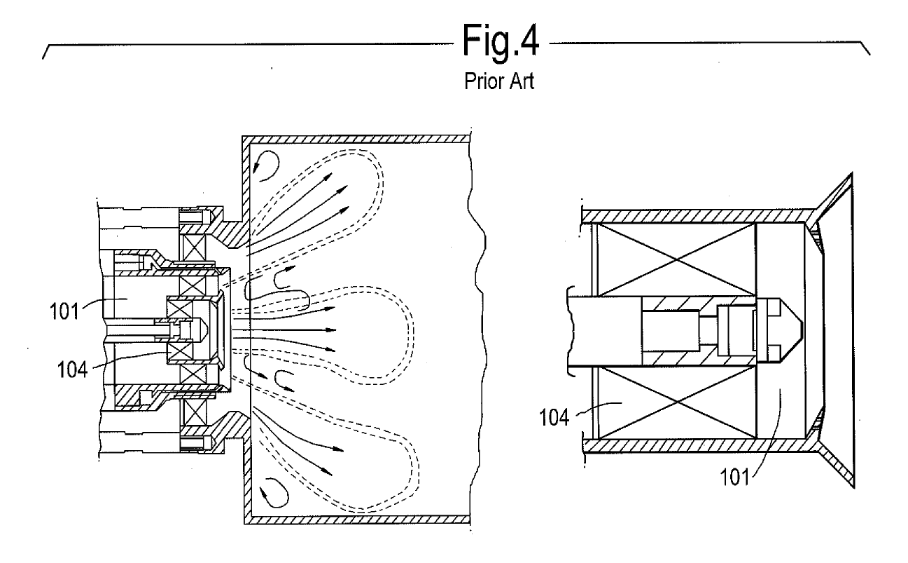

FIG. 3 depicts a fuel spray from a conventional pressure-jet ejector 50 in comparison with the fuel spray generated by the ejector of the invention 52. As can be clearly viewed in the diagram the fuel distribution 60 from the ejector of the invention is significantly wider than that 62 of the prior art at the pressure of 0.18 Barg. Accordingly, at low pressure altitude the improved fuel distribution aids the relight should flame extinction be noted.

Whilst the invention finds particular application in fuel injectors for gas turbine engines it may also find application in other fields which require atomisation of a liquid. Such technical fields may include, but not be limited to, farming and land vehicles.

What is claimed is:

1. A pressure jet liquid ejector comprising an axially located passage ending as a nozzle having an internal surface facing radially inwardly towards the axis, extending as an outboard cone about the axis of the passage and terminating at a tip, and an outer surface facing radially outwardly away from the axis and intersecting with the internal surface at the tip, wherein the outer surface has a profile for accelerating a gaseous flow over the outer surface.

2. A liquid ejector according to claim 1, wherein the outer surface has a radius from the axis that varies along the axial length of the outer surface to provide the profile.

3. A liquid ejector according to claim 2, wherein the radius along the axial direction decreases and then increases to provide an annular depression with an axially rearward lead in and an axially forward lead out.

4. A liquid ejector according to claim 3, wherein the outer surface has an axially extending annular portion of constant radius between the end of the axially forward lead out and the tip.

5. A liquid ejector according to claim 1, wherein the outboard cone extends outwardly at an angle between 30° and 70° to the axis.

6. A liquid ejector according to claim 5, wherein the angle of the outboard cone replicates the unconstrained trajectory of swirling fuel leaving the passage in use at the highest fuel flow required.

7. A liquid ejector according to claim 1, wherein the profile of the transition from the passage to the outboard cone matches the unconstrained fuel trajectory.

8. A liquid ejector according to claim 1, wherein at least part of the passage is radially inward of an insulating sleeve for providing resistance to the transfer of heat from the gaseous flow to the passage, wherein the outer surface of the insulating sleeve provides at least part of the outer surface.

9. A liquid ejector according to claim 1, wherein the passage has swirl means for imparting swirl to a liquid which flows through the supply passage in use.

10. A liquid ejector according to claim 1, wherein the ejector has a housing which defines with the outer surface a gaseous flow passage through which, in use, a gas flows.

11. A liquid ejector according to claim 10, wherein the gaseous flow passage has swirling means for imparting swirl to the gas flow.

12. A liquid ejector according to claim 1, wherein the axis is the axis of a lean burn fuel injector for a gas turbine and the ejector further comprises a further fuel injector arranged concentrically about the axis and located radially outwardly of the outer surface.
